(19) United States
(12) Patent Application Publication
(10) Pub. No.: US 2016/0012512 A1
(43) Pub. Date: Jan. 14, 2016

(54) LIFESTYLE RECOMMENDATION SYSTEM

(71) Applicant: Microsoft Corporation, Redmond, WA (US)

(72) Inventors: Neta Haiby, Hertzaliya (IL); Elad Ziklik, Modi'in (IL); Ronen Yaari, Tel Aviv (IL); Efim Hudis, Bellevue, WA (US); Royi Ronen, Tel Aviv (IL); Yuri Gurevich, Edmonds, WA (US)

(21) Appl. No.: 14/329,979

(22) Filed: Jul. 13, 2014

(51) Int. Cl. G06Q 30/06; H04W 4/02

(52) U.S. Cl. CPC G06Q 30/0631; H04W 4/02

(57) ABSTRACT

Disclosed herein is a system and method for generating a user profile for a user from multiple different data sources and providing recommendations to a user that are directed to benefiting the user and not benefiting a particular merchant or service provider. This disparate data is taken from multiple different data sources that are often competitors of one another. From the multiple data sources the same transaction or event can be determined and correlated with each other. This information is then processed to generate the user's profile which is used to generated recommendations for the user based on the user's needs. Recommendations that are presented can be positive or negative recommendations.

### TECHNICAL FIELD

This description relates generally to a recommendation system that makes lifestyle recommendations for a user to perform or not perform certain activities based on their profile.

### BACKGROUND

Recommendations and recommender systems make recommendations to users based on a comparison of the user's profile with profiles of other users who make use of a marketplace. However, these recommendations have historically been based off of the relationships between items. Typically this has been in the form of “people who have bought this have also bought these items”. More advanced systems of recommendations look at the items themselves to determine if the items are related and the user may be interested in the items based on a similarity between the item being looked at and these items. However, these recommendation systems are limited in that they are based on the needs of the merchant offering the recommendations and not based on other needs, wants or desires of the consumer. The goal of the recommendation systems is to have the user buy a particular item from the merchant.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for providing recommendations to a user that are directed to benefiting the user and not benefiting a particular merchant or service provider. The system takes disparate data from multiple different data sources that are often competitors of one another. From this information a profile for the user is generated which associates various events from the different data sources to produce a profile of the user's wants, needs, activities etc. The system also identifies the same event from the multiple data sources to produce a clearer picture of the event. From this profile the lifestyle recommendation system is able to generate recommendations for the user that are independent of the needs or desires of any particular merchant or vendor. These recommendations can be both positive and negative recommendations.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating the components of the lifestyle recommendation system according to one illustrative embodiment.

FIG. 2 is a block diagram illustrating an example recommender system according to one illustrative embodiment.

FIG. 3 is a flow diagram illustrating a process for generating a user profile according to one illustrative embodiment.

FIG. 4 is a flow diagram illustrating an exemplary process for providing recommendations to the user according to one illustrative embodiment.

FIG. 5 illustrates a component diagram of a computing device according to one embodiment.

Like reference numerals are used to designate like parts in the accompanying drawings.

### DETAILED DESCRIPTION

Typical recommender systems recommend to users and consumers items that they would be interested in purchasing or that others with a similar profile have also purchased. However, these systems are generally based or dependent upon the merchants desires to push or sell products. As such the information used to make the recommendations are often biased towards the consumer purchasing the item. In making these recommendations there is a large amount of information related to the consumer that is simply not considered in the traditional recommender system. Information related to credit cards that the consumer has or health recommendations that the consumer has received are often not part of the information used in generating a recommendation. This information can be useful to the consumer in making better and more informed decisions as to what to purchase and how to purchase a product or a service. Further, this information can be used to make a negative recommendation. That is the recommendation is to refrain from performing a certain action. This is what is considered to be a lifestyle recommendation, where the recommendations are made without concern for what a particular establishment wants the user to do, but what makes the most sense for the user.

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

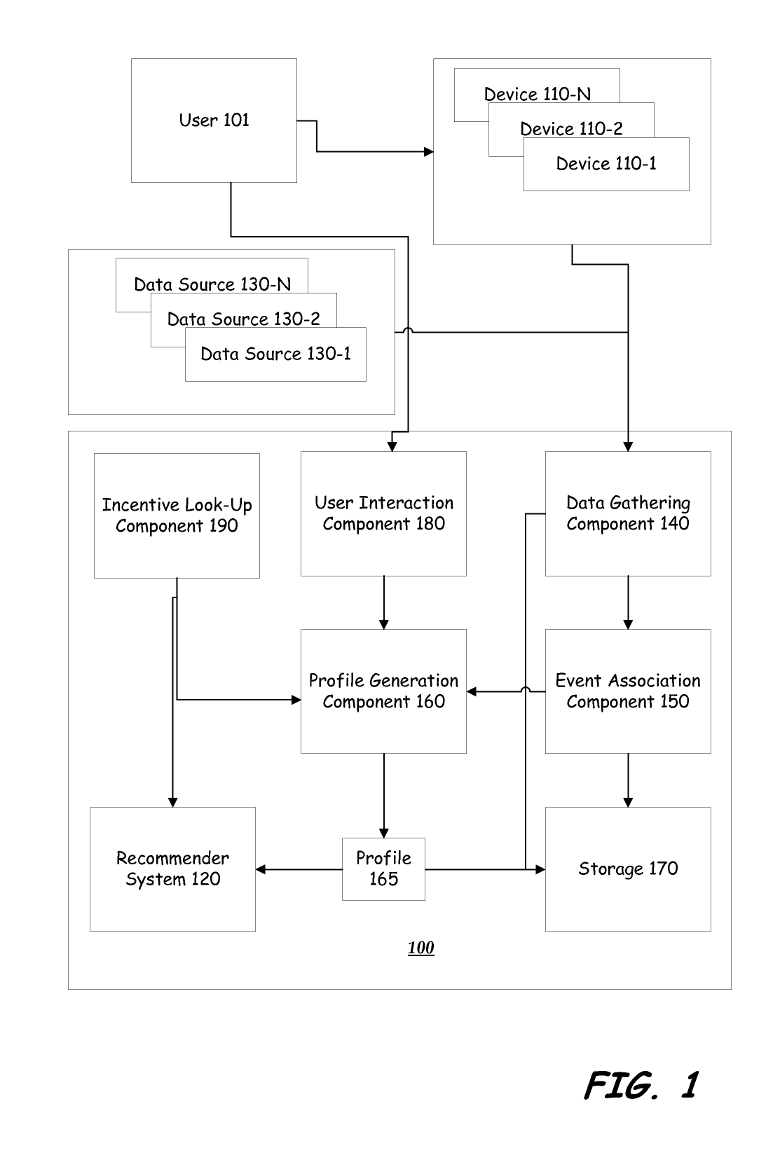

FIG. 1 is a block diagram illustrating components of the lifestyle recommendation system 100 according to one illustrative embodiment. Lifestyle recommendation system 100 includes at least one user, devices 110-1, 110-2, 110-N (collectively device or devices 110), recommender system 120, data sources 130-1, 130-2, 130-N(collectively data source 130 or data sources), a data gathering component 140, an event association component 150, a profile generation component 160, storage 170, and an user interaction component. While all of these components are illustrated in FIG. 1 in some embodiments various components may or may not be present depending on the desired set up of the lifestyle recommendation system 100.

User is in one embodiment a single individual. This individual participates in the lifestyle recommendation system 100 by, for example, registering to use the lifestyle recommendation system 100 through an online portal or other user interaction component. In other embodiments, the user may be registered into the lifestyle recommendation system 100 by another individual, such as an employer, a doctor, spouse, a merchant, a bank or some other entity that the user has a relationship with. In some embodiments the user can be more than a single individual. This typically can occur, for example, when a family registers with the lifestyle recommendation system 100. In this approach the lifestyle recommendation system 100 can consider the entire needs of the family in making the recommendations to the individuals who comprise the family. Alternatively, a corporation or other entity that has multiple members can also join as a group user.

Devices 110 are in one embodiment the devices 110 that a user has access to at various times of the day. These devices 110 can include personal communications devices 110, such as mobile phones, pagers, personal digital assistants (PDA), tablet computers etc. Devices 110 can also include personal computers, desktop computers, laptop computers, e-readers, televisions, household appliances (such as refrigerators, washers, dryers, ovens etc.), exercise equipment, wearable health monitoring equipment, etc. Each of the devices 110 have at least one application on them that can provide information to and/or receive information from the lifestyle recommendation system 100. Devices 110 are also connected to the lifestyle recommendation system 100 through a network 125 such as the internet. However, in some embodiments some devices 110 may connect to the network through other networks such as a wireless network or a cellular network. Some devices 110 may need to be physically connected to another device prior to communicating with the lifestyle recommendation system 100.

Data sources 130 are the sources of the information that provide activity information to the lifestyle recommendation system 100 based on the various activities of the user. These data sources 130 can be any device, application, person, etc. that can provide data about the user to the lifestyle recommendation system 100. The data sources 130 can be grouped into different categories of data sources 130 based on the information that they provide or are associated with. These groupings are for illustrative purposes and are not intended to be all inclusive or exclusive. Further, it should be recognized that a data source 130 in one group could also be considered a data source 130 for another grouping.

A first group of data sources 130 can be grouped around financial data. This first group can include credit cards, checking accounts, savings accounts, debit cards and the like. This group provides to the lifestyle recommendation system 100 information related to financial activity that the user has conducted as well as the user's current financial situation (e.g. debt, bank balances, etc.). For example if the user used a specific credit card to purchase a group of items, that transaction would appear in the data set for that particular credit card. This information may include the date of the transaction, a transaction id, a merchant name, a merchant category and a total amount charged to the card. Each credit card that the user has may report this information into to the lifestyle recommendation system 100. Similarly each bank account can provide data to the lifestyle recommendation system 100. While not having the same information as a credit card valuable information can be obtained from the transaction data there as well. This data can include information related to deposits made, ATM withdrawals, cash withdrawals, checks cashed, etc. Each of these transactions may also include the location or branch where the transaction was made along with the date of the transaction. In some embodiments a copy of a cashed check can be obtained and passed through an application that can glean from the check the payee of the check, the date the check was written and the account number on the check as well as any memo information contained on the check.

A second group of data sources 130 can be grouped around merchants. Merchants often offer patrons loyalty cards or other incentives to visit and purchase goods and services from that particular merchant. Each time the user uses the loyalty card with the merchant data is gathered related to the specific transaction. This information can include the products purchased, the location where purchased, the amounts purchased, total spend, coupons redeemed, etc. The merchant can use this information to better target the consumer with offers and such to continue to encourage the consumer to visit or use the merchant. The merchant may make the consumer's buying history available to them through the merchant's own portal. Other types of data sources 130 that may be included in this second group of data sources 130 include other types of loyalty programs such as those run by travel related entities such as airlines, hotels and car rental companies. In these programs data related to the person can be extracted based on the reported travel patterns such as when they were traveling, where they traveled, how they got there, how much they spent. In some embodiments the ability to see a breakdown of the bill associated with the travel can also be obtained from the loyalty information.

A third group of data sources 130 can be grouped around lifestyle events. This group of data can include data that is maintained about the health of the user. These data sources 130 can include medical and dental records, records associated with health and fitness clubs and the like. Also, the user's medical professionals can place information into the user's data such that the medical professional can ensure that their recommendations and health guidance can be used. This information may be entered directly by the user or obtained from a portal associated with the user where the health care provider can enter in this data as well. In some embodiments this data is obtained from a portal associated with the health care provider.

A fourth group of data sources 130 can be data sources 130 that the user provides to the lifestyle recommendation system 100. This data can be data that user directly enters in to the lifestyle recommendation system 100 through the user interaction component. This data can also be data that is extracted from applications that the user uses such as a calendar application. In this data can be data that relates to when the user has appointments and may also indicate who the user has been communicating with on a regular basis. Other information that can be obtained from applications may include topics the user is searching for on the internet, the subject of documents the user is working on, instant messaging conversations, etc. Other information may be obtained from, for example, receipts that the user has scanned into the system that includes specific items purchased, time of the transaction, card used to make the purchase (or if cash was used), location, etc.

A fifth group of data sources 130 is data that comes directly from the devices 110 themselves. This information can include location information indicating where the device is at a given time, motion information indicating if the user is stationary or not and/or how fast the user is moving, and activity information indicating if the user is using the device or not. The device may also provide data related to the specific activity the user is performing such as surfing the web, or running an exercise program on the device. Any data that can be obtained from the device can be part of this data.

Each data source 130 provides its data to a data gathering component 140. The data gathering component 140 in one embodiment only gathers data from data sources 130 that the user has authorized the lifestyle recommendation system 100 to gather data from. In this way the user is able to protect their privacy and only share with the lifestyle recommendation system 100 information that they desire to share. In some embodiments, the lifestyle recommendation system 100 can gather some data automatically without explicit consent of the user. Typically, this would occur in a scenario where the information is already in the public domain, such as a user whose Facebook account is open to the public with no limitations or other restrictions. One of the advantages of the lifestyle recommendation system 100 is the ability to correlate information from multiple sources that typically don't share information with each other, such as in credit cards where American Express doesn't share spending information of a consumer with Visa.

The data gathering component 140 gathers data from the various data sources 130 that have been registered to the lifestyle recommendation system 100. As data from each data source 130 comes in the data gathering component 140 takes the information and stores it in the data storage 170. In one embodiment the data gathering component 140 stores each piece of data as a unique record in a database. However, any other storage 170 mechanism can be used to store the data from the data sources. In this way every transaction can exist as a unique record separate from all of the other transactions and activities of the user. In some embodiment the data gathering component 140 can add the various data sources 130 to the item catalogue. In many instances the data source 130 is something that may also be recommended to the user. (e.g. recommending the use of a specific credit card).

The event association component 150 is a component of the lifestyle recommendation system 100 that takes the data from the data sources 130 and attempts to correlate or associate the different data events from the different data sources 130 as a single event. In this way the event association component 150 is attempting to correlate data between different data sources 130 in an attempt to identify the entirety of a transaction from the multiple data sources. The event association component 150 can receive the data directly from the data gathering component 140 prior to the data being stored or can access the stored data from the data storage 170 to perform the associated matching.

For example, the event association component 150 may receive from a credit card statement data that the user spent $45.00 at a grocery store and that the transaction posted on May 5, 2014. The event association component 150 may receive data from a device data that indicates that the user was at a QFC grocery store in Issaquah Wash. on May 5, 2014 at 7:35 pm. From this information the event association component 150 can infer that the $45.00 was spent at the QFC in Issaquah at 7:35 pm. This information can then be consolidated into the data storage 170 as a single event with more data than is currently available from the single source. The event association component 150 in this example may receive from the data source 130 associated with a loyalty program associated with the grocery store that provides a list of items that were purchased at the QFC in Issaquah. The items that were purchased in this transaction can then be added to the overall data record in the data storage 170 for this transaction.

In some embodiments the ability to correlate data from multiple data sources 130 may not be as straight forward as using the raw data that is provided by the data sources. In these embodiments, the event association component 150 may use other sources of information to make the correlation. For example, if a device reports back raw GPS coordinates the event association component 150 may access an application or data store that can identify what is located at the specific location associated with the raw GPS coordinates. In some embodiments the event association component 150 may use check-in data from a social network such as Facebook, Foursquare or Google+ to correlate the data with a specific transaction or even. Check-in data can be somewhat reliable with the locating where the user is. Specifically, because the user positively states where they are, it is possibly more reliable than location coordinates derived from other sources.

The event association component 150 analyzes the data from the data sources 130 either on a continuous basis or on a periodic basis. In this way the constant slew of activities that a user performs is kept relatively current. When the user adds to the lifestyle recommendation system 100 a new data source 130 the event association component 150 may use that data from the new data source 130 to enhance older associations when the new data provides a historical look back period. That is when the data from the new data source 130 includes data from the past, such as through an annual statement or allowing access to past statements. As events are identified and associated with each other across multiple data sources 130 the now correlated events are stored as unique records in the data associated with the user.

The profile generation component 160 is a component of the system that takes the data associated with the user and builds a profile 165 of the user. The profile generation component 160 access the records associated with the user found or obtained by the data gathering component 140 or the event association component 150 and finds similarities between the various records. That is the profile generation component 160 looks at the records and determines which of the records are related to each other. This relationship can include the records are all related to the same transaction or that the records place an order to events in a series of activities.

For example, the data associated with the user may show that there are multiple records that indicate that on Thursdays at 7:00 pm the user goes grocery shopping at a QFC and pays for the bill with their Visa card. From this the profile generation component 160 adds to the user's profile an entry that says basically “on Thursday the user goes grocery shopping and pays with their Visa card”. The profile generation component 160 may also note that on the first Thursday of the month the user spends approximately $200.00 on groceries, but on the other Thursdays the user only spends approximately $40.00. From this information the profile generation component 160 learns that the user does a large grocery shopping on the first of the month and does smaller bits on the other Thursdays.

Continuing on the profile generation component 160 can for example determine events that occur before and after other events. In this way the profile generation component 160 can learn a series of behaviors that occur in a typical sequence. Using the above example regarding grocery shopping, it may be learned that if the user leaves their place of employment on a Thursday at 5:00 pm and goes to the health club then they do not go to the grocery store. As such the profile generation component 160 adds to the profile an entry that basically represents the idea that the user “Leave Office at 5 go to Health Club no Grocery on Thursday”. The profile generation component 160 continues to build the profile for the user by identifying events that are similar to each other and determining what makes those events similar to each other. In determining if events are similar the profile generation component 160 can use any type of similarity determination available, include cosine similarity measure and Jaced similarity measure. The profile generation component 160 also continues to identify event orders and other related events around the events to determine an overall event timeline or activity patter between events.

The profile generation component 160 can also add features into the profile based on information received from the devices 110. For example, if the user has a refrigerator that can determine when an object enters or leaves the refrigerator, the refrigerator may report data to the lifestyle recommendation system 100 when an object leaves the refrigerator, but is not returned in a predetermined period of time. This can be indicative of the user having used the item and therefore needing to purchase that item again. The profile component can use this information to add an entry to the profile indicating that the user needs this item. Further, information received from health care providers can be added to the user's profile such that health recommendations can be incorporated into the profile and later recommendations to the user.

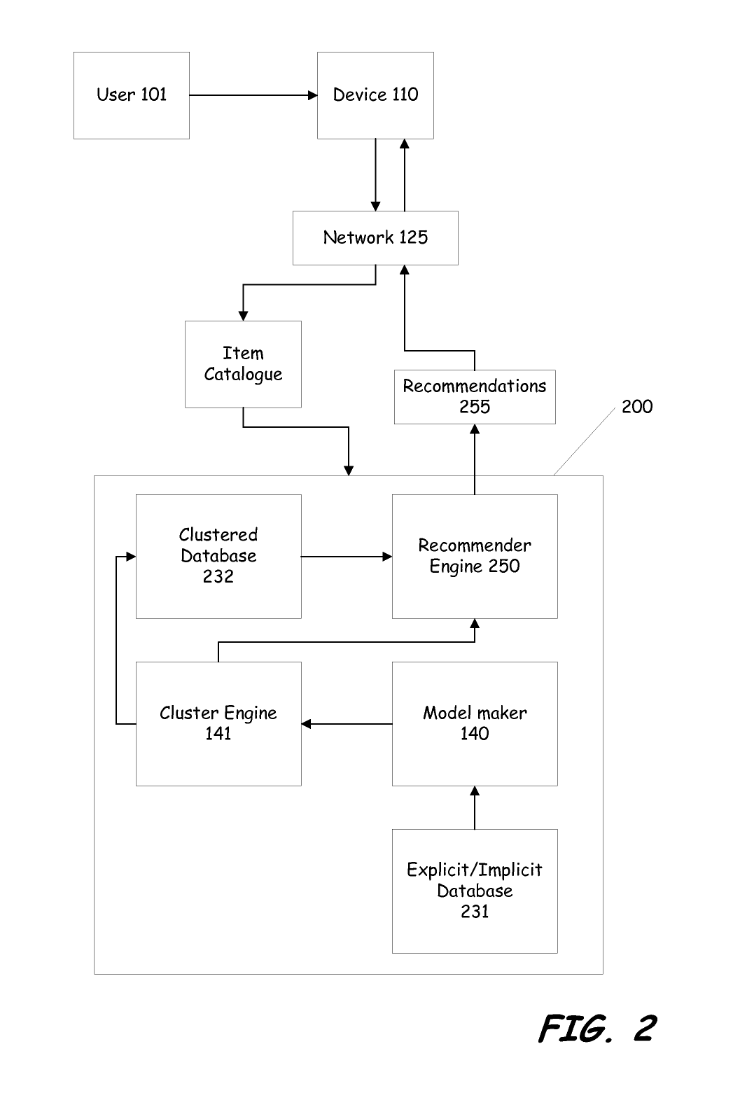

The recommender system 120 is in one embodiment a component of the lifestyle recommendation system 100 that produces recommendations for the user at the appropriate time. An example of a recommender system 120 that can be used herein is described with respect to FIG. 2. The recommender system 120 receives information related to the location of the user from the devices 110 through the lifestyle recommendation system 100 and uses this information to make recommendations to the user based on the entries in the item catalog. In some embodiments the recommender system 120 may make recommendations to the user based on their profile and the current time or other information that is provided from the lifestyle recommendation system 100 regarding what the user is currently engaged in.

FIG. 2 schematically shows a recommender system 200 (such as the recommender system 120 in FIG. 1) operating to provide recommendations 255 to users such as user 101, that may access the recommender system 200 through a lifestyle recommendation system 100, such as lifestyle recommendation system 100, using a device 270 according to one illustrative embodiment. However, any available recommender system 120 may be used. Recommender system 200 in some embodiments comprises an “explicit-implicit database” 231 comprising explicit and/or implicit data acquired responsive to preferences and needs exhibited by the user 101 for items and actions in a catalog of items. Recommender system 200 may comprise a model maker 240 and a cluster engine 241 that cooperate to cluster related catalog items in catalog clusters and generate a clustered database 232. A recommender engine 250 recommends catalog items from catalog clusters in clustered database 232.

It should be noted that while this description herein refers to a catalog of items or item catalogue, the catalog of items is more than simply items that can be recommended to the user. The catalog of items includes activities the user can engage in, products the user could purchase or needs to purchase, credit cards that the user has, etc. The catalog of items can include anything that the system could recommend to the user to either purchase or not purchase, consume or not consume, or do or not do. This additional information or data in the catalogue may be generated by the data gathering component 140 or the profile generation component 160.

Explicit data optionally comprised in explicit-implicit database 231 includes information acquired by recommender system 200 responsive to explicit requests for information submitted to users 101 in the population. These requests can be obtained in one embodiment from the user 101 when the user generates their personal profile with the lifestyle recommendation system 100 or first interacts with the recommendation system 100. Explicit requests for information may comprise, for example, questions in a questionnaire, requests to rank a book or movie for its entertainment value, requests to express an opinion on quality of a product, or requests to provide information related to likes and dislikes that may be determined by the system. Implicit data in the explicit-implicit database 231 can includes data acquired by the recommender system 200 responsive to observations of behavior of the user 101 that is not consciously generated by an explicit request for information. For example, implicit data may comprise data responsive to determining how the user uses content displayed by the device 270 or how the user goes about the day. In some embodiments the information is acquired through the profile generation component 160.

Model maker 240 processes explicit and/or implicit data comprised in explicit-implicit database 231 to implement a model for representing catalog items that represents each of the catalog items by a representation usable to cluster the catalog items. Cluster engine 241 processes the representations of the catalog items provided by model maker 240 to generate “clustered database” 232 in which the plurality of catalog items is clustered into catalog clusters, each of which groups a different set of related catalog items. While FIG. 1 schematically shows explicit-implicit database 231 as separate from clustered database 232, clustered database 232 may be comprised in explicit-implicit database 231. To generate clustered database 232, cluster engine 241 may for example simply mark records in explicit-implicit database 231 to indicate clusters with which the records are associated.

Any of various models for providing representations of catalog items and methods of processing the representations to cluster the catalog items and generate clustered database 232 may be used in practice of an embodiment of the invention. Model maker 240 may for example generate representations of catalog items that are based on feature vectors. Optionally, model maker 240 represents catalog items by vectors in a space spanned by eigenvectors, which are determined from a singular value decomposition (SVD) of a “ranking matrix” representing preferences of user 101 for the catalog items. Model maker 240 may represent catalog items by trait vectors in a latent space determined by matrix factorization of a ranking matrix. However, other methods may be employed.

Cluster engine 241 optionally clusters catalog items in a same catalog cluster if same users exhibit similar preferences for the catalog items. Optionally, cluster engine 241 uses a classifier, such as a support vector machine, trained on a subset of the catalog items to distinguish catalog items and cluster catalog items into catalog clusters. In an embodiment, cluster engine 241 uses an iterative k-means clustering algorithm to cluster vectors representing catalog items and generate clustered database 232.

Referring back to FIG. 1 an incentive look-up component 190 is a component of the lifestyle recommendation system 100 that uses information in the user's profile that was generated by the profile generation component 160 to identify incentives that may apply to the user based on the content in the user's profile. The incentive look-up component 190 can take each of the user's credit cards and search on the associated website for the card to determine if the card is offering any incentives to encourage the user to use the card. The incentive look-up component 190 upon finding any incentives for the credit cards may add those incentives to the user's profile, or to the item catalogue.

The user interaction component 180 is a component of the lifestyle recommendation system 100 that allows the user to interact with the system. The user interaction component 180 can be a user interface or web page through which the user can set preferences and such for the system. The user interaction component 180 can allow the user to designate what portions of the data they want to share with the system. Further, the user can respond through the user interaction component 180 to queries that are generated by the lifestyle recommendation system 100 or various data sources 130 during the registration or data acquisition stages. In some embodiments the user has the ability to request a recommendation from the lifestyle recommendation system 100 through this component as well. This allows the user to receive an on-demand recommendation when the system may have determined that it didn't need to provide one to the user.

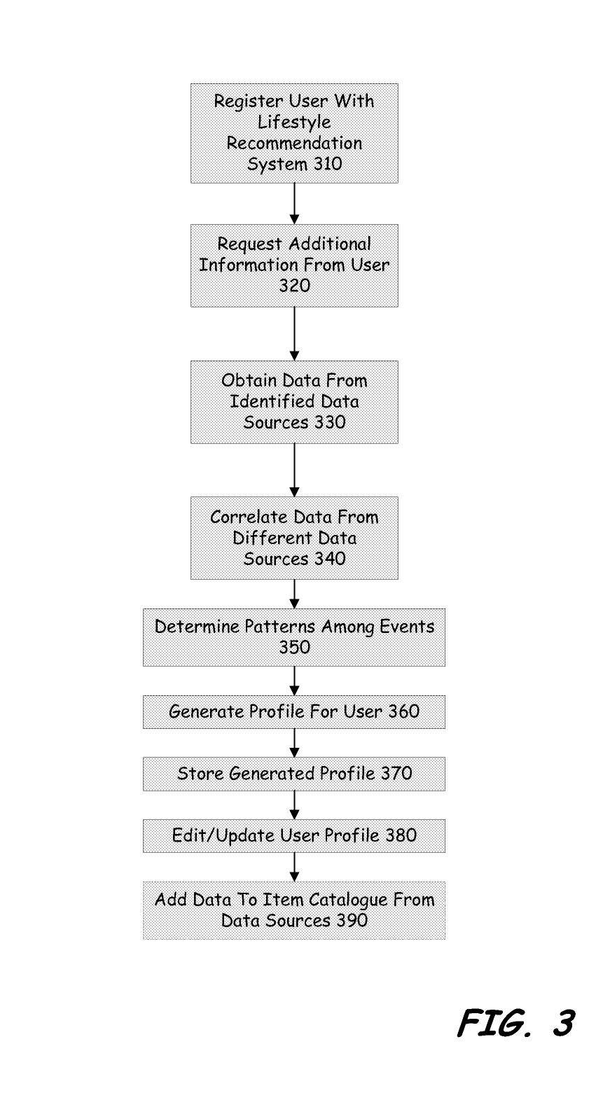

FIG. 3 is a flow diagram illustrating the processes for registering a user and building a user profile for the user in the lifestyle recommendation system 100. It should be noted that in various embodiments some of the steps may be omitted or performed in a different order.

The process begins when the user registers with the user interface component of the lifestyle recommendation system 100. This is illustrated at step 310. At this step the user provides basic information to the lifestyle recommendation system 100 that allows for the formation of a basic profile. This information may include age, gender, name, location, contact information etc. With this basic information the profile generation component 160 begins to build a base profile for the user. In some embodiments the profile generation component 160 searches for profiles that already exist for other users that are similar to the base information that the user has entered. If a similar profile is found the profile generation component 160 may use that similar profile as a base to generate the user's profile. However, in other embodiments the user's profile is generated without concern for other users of the lifestyle recommendation system 100.

Once the base profile for the user has been created by the profile generation component 160 the user may be then asked through the user interface component to provide additional information that is significantly more detailed than the basic information. This is illustrated at step 320. The user interface component can request this information from the use through a series of wizard menus or other means of prompting the user to provide various pieces of information. Through this data entry by the user of the various information the profile generation component 160 is able to better understand the user and the user's activity.

For example, the user may be first presented with a screen that requests the user to provide to the lifestyle recommendation system 100 all of the devices 110 that the user has that are connected to a network that the user wishes to register with the system. The user may then provide the address, phone number or other means for identifying the device to the system such that the system can communicate with the devices 110.

Next the user can be presented a screen that allows the user to enter in their financial information. This screen can prompt the user to identify the type of account the user has and also provide for login information to the account such that the system can login to the account and access the appropriate data from the account. In some embodiments, the user may be able to preselect certain financial providers from a list of providers that have agreed to participate in the lifestyle recommendation system 100. This allows the system to more easily obtain the information needed to generate the profile for the user. The user may also be able to recommend that certain providers be added to the lifestyle recommendation system 100.

The user continues to be presented with different screens through the user interaction component 180 that allows the user to enter in the information related to different categories or groupings of data sources. As such the process for entering this data repeats itself for each of the categories and groups that the lifestyle recommendation system 100 supports. Through this approach the user can provide access to their devices 110, accounts, emails, calendars, location, etc. The user may also be requested to provide information related to a website for the provider such that the incentive identification component can identify information that is contained on the providers website.

Once the information has been gathered the lifestyle recommendation system 100 reaches out to all of the data sources 130 that the user has indicated as wanting to participate in the system to obtain the data from these data sources. This is illustrated at step 330. The system logs into the appropriate systems and obtains the data from the data sources. If a particular data source 130 requires authentication when a new device logs in to the data source 130 for the first time, as is currently common with credit card websites, the lifestyle recommendation system 100 may interact with the user to gain the appropriate authentication information to make the lifestyle recommendation system 100 a trusted device. If the particular data source 130 requires authentication each time to access the data, such as is common with sites protected by and RSA key, the lifestyle recommendation system 100 can again interact with the user to request the current RSA key from the user. In this way the lifestyle recommendation system 100 is able to obtain the information even from sites that make it difficult for access not directly from the user or from sites that would prefer not to make the information that they hold easily accessible.

Once the data from the data sources 130 has been obtained, the event association component 150 takes all of the data and attempts to correlate this data between the different data sources. This is illustrated at step 440. The event association component 150 looks at the data behind each of the records and matches them with other records that are likely related to the same transaction. For example the event association component 150 can use GPS or location data from a mobile phone and correlate it with a transaction at a grocery store where both pieces of data have a same transaction date. From the combination of the two different data sources 130 more data about a particular event is now known. This process of correlation by the event association component 150 continues until all of the data has been processed through the event association component 150. In some embodiments the event association component 150 makes a new event record for the correlated data and removes the source event. In other embodiments the source events are maintained as well.

After the events have correlated from among the various data sources, the profile generation component 160 looks to determine patterns among the events. This is illustrated at step 350. The profile generation component 160 looks to see if a series of events occur in a specific order or on a specific day. This information is then used to add additional context to the user profile. As such, the profile generation component 160 is able to learn and leverage the user's patterns in associating events and later making recommendations.

Following the event association process the profile generation component 160 generates a profile for the user based on the correlated events. The process of formation of the profile can be done using any profile generation process. This is illustrated at step 360. In some embodiments the profile generation component 160 creates a single profile for the user based on all of the data from the data sources. In other embodiments the profile generation component 160 generates different profiles for the user for different activities or times of the day. In this way the system can have for a “work profile”, a “home profile” and a “vacation profile” for a single user. Depending on what the user is doing the system may apply a different profile for the user that may be more appropriate for that particular time with the user. In other embodiments the profile generation component 160 can have both a single profile for the user based on all of the data sources, as well as the specialized profiles. This can allow the system the best of both worlds of a specialized profiles when the system is confident that it fully understands what the user may want and a basic profile to fall back upon when the system cannot apply the specific profile to the current user's situation. The user's profile is then stored in the storage 170. This is illustrated at step 370.

While the user is using the lifestyle recommendation system 100 their profile is constantly being updated behind the scenes by having the system access the various data sources 130 or receiving information from the various data sources. However, at any time the user can go back into the system through the user interaction component 180 and add or delete data sources 130 from the system. When this occurs the system returns back to step and repeats the process for generating the user's profile. If the user is deleting a data source 130 from the system a new profile for the user may be generated. In some embodiments the old profile is overwritten. However, in other embodiments the old profile is maintained and the new profile is generated using only the current information and excluding the removed information. In other embodiments the new profile is simply built or added to the old profile, but going forward the profile is not enhanced with data from the removed data source 130. This is illustrated at step 380.

Additionally, in some embodiments, the data and the data sources 130 that the user has registered with the lifestyle recommendation system 100 are also entered into the item catalogue as items. In this way the user's credit cards, financial information, likes, dislikes, devices 110, items, etc along with associated data related to them are part of the item catalogue that the recommender system 120 will access when generating a recommendation to the user based on their lifestyle. Through this the data from the data sources 130 work together not only in building the user's profile, the item catalogue, but also in making the recommendations. This is illustrated at step 390.

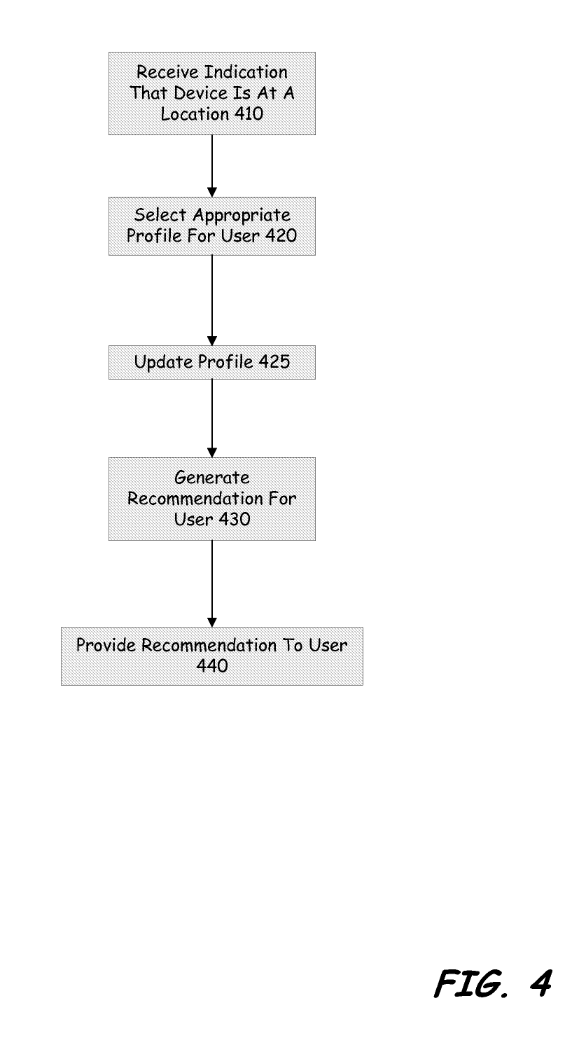

Once the user's profile has been created the use is now able to use the lifestyle recommendation system 100 in their day to day life. FIG. 4 is a flow diagram that illustrates an exemplary process of providing recommendations to the user based on their current lifestyle and their profile. In some embodiments the system automatically generates the recommendation for the user. However, in other embodiments the user can request the recommendation through the system. In other embodiments, recommendations can be generated automatically and on-demand from the user.

The process begins with one of the user's devices 110 reporting to the lifestyle recommendation system 100 that the user is at a particular location or is performing a particular activity. This is illustrated at step 410. This information can be the GPS data from the user's mobile phone, a report from the user's desktop that they are currently shopping at a web portal, etc. In some embodiments the system will take location information from the device and search a data store of information that correlates the location information with a specific location or activity. For example, it may correlate the location information with shopping mall known to be at that location, the location corresponds to a specific park or that the location is the user's home. This location correlation data can be stored internally to the system, located at a remote site, or may even be obtained by the system performing a search on the internet to identify what is located at the particular location.

Once the location or activity is known the lifestyle recommendation system 100 then selects the appropriate profile for the user. This is illustrated at step 420. In some embodiments the system will select the base profile for the user that is based upon all of the user's data. In other embodiments a specific profile for the user may be selected. The specific profile that is selected can be based on the information related to the user's current location or activity, or can be based on other factors such as the current time of day. Once a user profile has been selected the profile is provided to the recommender system 120.

Prior to the recommender system 120 processing the user's profile the profile may be updated by the lifestyle recommendation system 100. This is illustrated at optional step 425. At this step the lifestyle recommendation system 100 may determine if additional information needs to be added to the user's profile. For example, the lifestyle recommendation system 100 may search the websites associated with the user's credit cards to determine if there are any incentives for using the particular credit card at any locations. If the lifestyle recommendation system 100 discovers that there are incentives for using a credit card at a particular location this information can be added to the profile. Often times the promotions or incentives are temporary in nature and as such are not informative to the overall user's profile, but may be relevant to a specific transaction the user may make. One example of a short duration event is “Small Business Saturdays” that is put on by American Express. Another example, is that certain credit cards have bonus points for specific spend in specific categories of merchants for a week at a time or a month or even a specific day of the month. These incentive programs are useful in making a recommendation, but given their temporary and fleeting nature are not necessarily something that is desired in the main profile for the user. However, in other embodiments this information would have been part of the profile to begin with. In this manner the system is able to make sure the information in the profile is as current as possible.

The user's profile is provided to the recommender system 120 along with information related to the user's current location and/or activity to generate a recommendation for the user. This is illustrated at step 430. The recommender system 120 takes the user's profile, the current location and the item catalogue and makes a recommendation to the user on a specific action the user may want to take. For example, the recommender system 120 may determine that the user is at a grocery store and one of their cards that the user currently has is offering triple points on purchases at grocery stores. As such the recommender system 120 may generate a recommendation that tells the user that ABC card is offering triple points for purchases at a grocery store. The recommender system 120 may in this example also have determined from the user's profile that they are booking a trip to Europe and have been looking for a hotel in Europe to stay at on points from a DEF loyalty program. With this information in the profile as well the recommender system 120 may discover that HU credit card that the user has is a transfer partner of DEF loyalty program, but is not offering the triple points that ABC card is offering. In this example the recommender system 120 may weight each of the two recommendations to determine which recommendation to provide to the user. In making this recommendation the system may determine other data that could be influential to the user, such as considering their current point balance with DEF loyalty program and the number of points DEF program requires for free nights at a hotel in Europe. If the user is a long way away from the points required that may cause the recommender system 120 to weight HU card recommendation lower than the ABC card. However, if the user is very close to the number of points required the recommender system 120 may cause the HU card to be weighted higher than the ABC card.

Once the recommendation has been generated by the recommender system 120 the lifestyle recommendation system 100 presents the relevant recommendation to the user. This is illustrated at step 440. The recommendation that is presented to the user may be dependent on the specific device the user is using as well as what the user is currently doing. For example if the user is at their desktop computer the recommendation may come via an email or a pop-up window. If the user is using a mobile phone the recommendation may be delivered as a text or SMS message. If the user is driving the recommendation may be made via a voice message that is automatically played to the user such that the user does not have to directly interact with the system. In some embodiments the user may be presented with multiple different recommendations along with a rational for the recommendation. For example as discussed above the user may have two cards that the user may want to use to complete a purchase but may want to use them for different reasons. The recommendation can provide to the user both recommendations and explain why each is presented to the user. So the recommendation could be that “I see that you are at the grocery store. ABC credit card is giving triple points at grocery stores, but HIJ card is a transfer partner with DEF and you can earn points towards a trip to Europe.” In this way the user is then able to see both recommendations, but also understand why one may be better than the other for the user at this particular point in time.

The following is an example of the lifestyle recommendation system 100 in operation with a user over the course of a day. When the user is using the lifestyle recommendation system 100 the user continues doing their normal activities without concern for what the system is doing in the background. It is only when a recommendation is determined to be relevant from the system does the user even become aware of the advantages of the lifestyle recommendation system 100. The following is an example of how the user could experience the lifestyle recommendation system 100 after the user's profile has been created by the profile generation component 160.

The user starts their day by getting out of bed and checking their email on their mobile phone and beginning their daily routine. When they head to their kitchen they open their refrigerator and remove a carton of milk from the refrigerator. The refrigerator detects that the milk has left the refrigerator. However, the milk is not returned to the refrigerator. The refrigerator noting that the milk was not returned communicates with the lifestyle recommendation system 100 to indicate that the milk was not returned. The lifestyle recommendation system 100 processes this information into the user's profile. Based off this information the profile generation component 160 determines that the user needs milk and as such modifies the user's profile such that an indication that the user's needs milk is now present. The user continues on with their morning routine.

The user steps into their car and begins their morning commute. Their mobile device begins reporting movement of the user in the car including the user current location and speed. As the system has learned that on Thursdays the user usually fills their car with gas at a particular gas station along the route to their office. When the user approaches the gas station the lifestyle recommendation system 100 determines that the user needs a recommendation with regards to which credit card to use to pay for the gas. Specifically, the user is currently unaware, or may be unaware that one of their credit cards that they currently hold is giving triple points on the purchase of gas on that day. However, this card is different from the card that the lifestyle recommendation system 100 has determined that they usually use to purchase gas. The lifestyle recommendation system 100 causes a message to be sent to the user's mobile device (as opposed to other devices 110) that tells the user: “You usually use your American Express card to buy gas. However, today your Bank A Visa card is offering triple points on gas purchases.” Through this recommendation the user is now able to switch which card they use to purchase gas to gain a greater personal benefit. This recommendation to the user is based on what the user does and currently has and is not based on any external input from a merchant.

The user continues from the gas station to their office. While they are at the office they take a break and begin some online shopping. While they are browsing the online shopping portal the information related to what they have added to their cart and the particular site are captured and provided to the lifestyle recommendation system 100. The system processes this data and using their profile determines that a second recommendation would be useful prior to purchasing. In this instance the system determines that the user has a $20 gift card to the particular merchant site they are visiting that is sitting in an email, that their particular MasterCard gives a bill credit for the merchant and that they can also earn frequent flyer miles for the purchase, if the purchase is initiated through the shopping portal of the airline. The lifestyle recommendation system 100 then generates an email to the user that provides these three recommendations to the user prior to the user completing the transaction. These recommendations are packaged as a single email to the user and can include instructions on how to complete the transaction according to the recommendation. Again these recommendations are not based on any external input from any of the merchants involved.

Later in the day the user heads out to lunch with some colleagues. They choose a restaurant and the user checks-in to the restaurant on a social application. This check-in is reported back to the lifestyle recommendation system 100 along with GPS data from the user's mobile device. The user's doctor had recently told him that he needs to cut down on the amount of fat he was consuming. The lifestyle recommendation system 100 had added this information to the user's profile when the doctor added the reduced fat instructions to the user's health profile. Based on this information the lifestyle recommendation system 100 finds online the menu for the restaurant and identifies the low or lower-fat options on the menu. The system then sends a text message to the user that reminds them of the doctor's recommendations to reduce fat and makes some menu suggestions. Also because the system has learned the user doesn't like shrimp it omits from the recommendation any items that include shrimp. In this way the user is reminded of their doctor's recommendations and also provided with hints or guidance to the menu items that would be best for them.

The user continues about their day and the lifestyle recommendation system 100 continues to receive information from the various data sources 130 that are connect with the user and updates the user's profile as appropriate with any new information that is received. For example, while the user is at work his spouse uses the last of eggs that were in the refrigerator to make some cookies for their children. Again the refrigerator detected that the eggs were taken out of the refrigerator, but were not returned. So as before the refrigerator reports this information back to the lifestyle recommendation system 100 which then updates the user's profile to indicate that they need eggs as well as milk.

The user finishes their day at the office and begins the commute home. As this is a Thursday, the system presumes that the user is going to stop by the grocery store to do the usual Thursday shopping. However, because the user has had very difficult day at the office, the user forgot to stop for groceries. When the user's mobile device detects that they have gone past the grocery store, this information is passed back to the lifestyle recommendation system 100. The system quickly process this information and sends the user a text message or calls the user's mobile device with a message. This message may say to the user: “You normally get groceries on Thursdays after work. Did you forget?” or some other indication that the user is doing something outside of their routine. This simple reminder has the advantage of helping the user stay on track even when a curve ball has been thrown at them. Upon receiving this message the user realizes that he forgot to stop by the grocery store. The user in this instance decides to return to the grocery store. However, he simply could have decided to do the trip another day.

When the user arrives at the grocery store the lifestyle recommendation system 100 determines if the user needs any recommendations for the grocery store. In this instance the lifestyle recommendation system 100 determines that the user needs milk and eggs based off the report from the user's refrigerator. The system then adds to the user's shopping list in an application on their mobile device milk and eggs. Alternatively the system could send a message to the user that they are out of milk and eggs. Further, the lifestyle recommendation system 100 determined that the user's checking account that is associated with the Visa card that they usually use to pay for groceries is below a certain balance. As a result the lifestyle recommendation system 100 sends a second message to the user that alerts them that their balance is low and that they may want to use a different card to pay for groceries on this trip. In this way the user receives relevant recommendations about their current financial condition as well as other aspects of their own personal needs without the merchant recommending behavior.

When the user returns home with the items from the grocery store, the refrigerator recognizes that these items have been added back to the refrigerator and sends an update to the system that indicates that milk and eggs are no longer needed. As a result of this the profile for the user is updated to indicate that these items are no longer needed. Further, should the user return to the grocery store later that day or at another time there will not get a recommendation for milk and eggs, at least until such time as they run out of milk and eggs again.

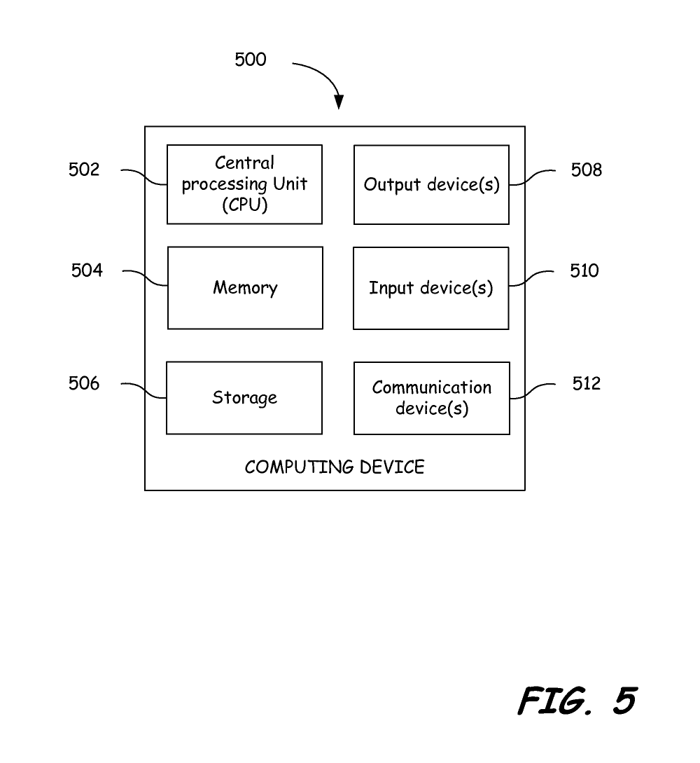

FIG. 5 illustrates a component diagram of a computing device according to one embodiment. The computing device 500 can be utilized to implement one or more computing devices, computer processes, or software modules described herein. In one example, the computing device 500 can be utilized to process calculations, execute instructions, receive and transmit digital signals. In another example, the computing device 500 can be utilized to process calculations, execute instructions, receive and transmit digital signals, receive and transmit search queries, and hypertext, compile computer code, as required by the system of the present embodiments. Further, computing device 500 can be a distributed computing device where components of computing device 500 are located on different computing devices that are connected to each other through network or other forms of connections. Additionally, computing device 500 can be a cloud based computing device.

The computing device 500 can be any general or special purpose computer now known or to become known capable of performing the steps and/or performing the functions described herein, either in software, hardware, firmware, or a combination thereof.

In its most basic configuration, computing device 500 typically includes at least one central processing unit (CPU) 502 and memory 504. Depending on the exact configuration and type of computing device, memory 504 may be volatile (such as RAM), non-volatile (such as ROM, flash memory, etc.) or some combination of the two. Additionally, computing device 500 may also have additional features/functionality. For example, computing device 500 may include multiple CPU's. The described methods may be executed in any manner by any processing unit in computing device 500. For example, the described process may be executed by both multiple CPU's in parallel.

Computing device 500 may also include additional storage (removable and/or non-removable) including, but not limited to, magnetic or optical disks or tape. Such additional storage is illustrated in FIG. 5 by storage 506. Computer storage media includes volatile and nonvolatile, removable and non-removable media implemented in any method or technology for storage of information such as computer readable instructions, data structures, program modules or other data. Memory 504 and storage 506 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 500. Any such computer storage media may be part of computing device 500.

Computing device 500 may also contain communications device(s) 512 that allow the device to communicate with other devices. Communications device(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 500 may also have input device(s) 510 such as keyboard, mouse, pen, voice input device, touch input device, etc. Output device(s) 508 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for building a user profile in a lifestyle recommendation system comprising:
registering a user with the lifestyle recommendation system;
collecting data related to the user from a plurality of different data sources;
identifying transactions within the collected data from the plurality of different data sources;
identifying a pattern between at least two transactions within the collected data from the plurality of different data sources; and
generating a user profile of user behavior based upon the identified transactions and the identified pattern between the at least two transactions.

2. The method of claim 1 further comprising:
associating at least two transactions in the collected data as relating to a first event.

3. The method of claim 2 wherein associating the at least two transactions associates at least a first transaction from a first data source with a second transaction associated with a second data source different from the first data source.

4. The method of claim 2 wherein associating at least two transactions further comprises:
associating at least two different transactions in the collected data as relating to a second event, the second event different from the first event.

5. The method of claim 1 wherein registering the user further comprises:
receiving personal information related to the user.

6. The method of claim 1 wherein registering the user further comprises:
receiving from the user an indication of the plurality of different data sources the user desires to collect data from; and
obtaining user access information for each of the plurality of different data sources from the user.

7. The method of claim 1 wherein registering the user further comprises:
presenting to the user a list of data sources to select;
receiving a selection from the user of at least two of the data sources; and
obtaining user access information for each of the at least two data sources from the user.

8. The method of claim 1 wherein collecting data related to the user further comprises:
accessing a first data source of the plurality of different data sources;
obtaining user specific data from the first data source;
accesses a second data source of the plurality of different data sources;
obtaining user specific data from the second data source; and
wherein the user specific data from the first and the second data source comprises transaction data for the user of a product associated with the first data source and the second data source.

9. The method of claim 1 wherein at least one of the at least two transactions comprises location data from a device associated with the user and at least another one of the at least two transactions comprises a financial transaction associated with the user.

10. The method of claim 1 further comprising:
updating the user profile on a periodic basis by collecting updated from the plurality of different data sources.

11. A lifestyle recommendation system comprising:
at least one processor;
at least one memory device;
a user profile wherein the user profile is based off of activities from a plurality of different data sources for the user;
a recommender system configured to provide the user at least one recommendation wherein the recommendation is based off information contained in the user profile and is not based on an external influencer and
at least one device associated with the user, the at least one device configured to provide the at least one recommendation to the user.

12. The lifestyle recommendation system of claim 11 further comprising:
a profile generation component configured to generate a user profile for the user from the plurality of different data sources.

13. The lifestyle recommendation system of claim 11 further comprising:
a data gathering component configured to access user specific information from each of the plurality of different data sources and identify a plurality of activities in data in each of the plurality of different data sources; and
an event association component configured to associate at least one activity from one of the plurality of different data sources with a corresponding activity in a different one of the plurality of different data sources.

14. The lifestyle recommendation system of claim 13 wherein the data gathering component is further configured to classify the each of the data sources as into one of a plurality of groups of data sources wherein each group of the plurality of groups includes data sources that are topically related to each other.

15. The lifestyle recommendation system of claim 11 wherein the recommender system is configured to receive location information from a device associated with the user and to determine an establishment where the user is located and to provide the recommendation based on the user profile and the determined location.

16. The lifestyle recommendation system of claim 15 wherein the recommendation is based on information in the profile that is not directly related to the establishment associated with the determined location.

17. The lifestyle recommendation system of claim 11 further comprising:
an incentive identification component configured to determine if a product associated with a particular data source is associated with an incentive to use the product at a particular location and to provide the identified incentive to the recommender system when the user is determined to be at the particular location.

18. A method for providing a recommendation to a user comprising:
determining that the user is at a particular location;
accessing a user profile associated with the user, wherein the user profile is based on a plurality of different data sources associated with the user and activities associated with the user from each of the plurality of different data sources;
providing the determined location and the user profile to a recommender system;
receiving from the recommender system at least one recommendation for the user to perform a particular action at the determined location, wherein the at least one recommendation is not based on influence from the determined location; and
providing the at least one recommendation to the user.

19. The method of claim 18 wherein the at least one recommendation is a recommendation to use a particular credit card at the determined location.

20. The method of claim 18 wherein the at least one recommendation comprises at least two recommendations wherein the at least two recommendations are recommendations that are mutually exclusive of each other.
